(19) United States
(12) Patent Application Publication
(10) Pub. No.: US 2026/0205955 A1
(43) Pub. Date: Jul. 16, 2026

(54) DEVICES, METHODS AND APPARATUSES FOR UPLINK TRANSMISSION POWER CONTROL

(71) Applicant: Nokia Technologies Oy, Espoo (FI)

(72) Inventors: Matha DEGHEL, Montrouge (FR); Keeth Saliya Jayasinghe LADDU, Espoo (FI)

(21) Appl. No.: 19/134,507

(22) PCT Filed: Nov. 17, 2023
(86) PCT No.: PCT/EP2023/082159

§ 371 Date: May 30, 2025

(30) Foreign Application Priority Data
Dec. 2, 2022 (GB) 2218159.8

(51) Int. Cl. H04W 52/14; H04W 52/36

(52) U.S. Cl. CPC H04W 52/146; H04W 52/367

(57) ABSTRACT

Embodiments of the present disclosure disclose a method and apparatus for uplink transmission power control. A terminal device obtains a power indication from a network device, wherein the power indication indicates whether the terminal device is allowed to use a transmission power greater than a threshold. Based on the power indication, the terminal device determines the transmission power for one or more uplink transmissions. Therefore, the transmission power for the uplink transmission may be well and dynamically controlled, thereby improving communication efficiency and communication performance.

### CROSS-REFERENCE TO RELATED APPLICATION

This application claims priority to, and the benefit of, GB application No. 2218159.8 filed on Dec. 2, 2022, which is incorporated herein by reference in its entirety.

### FIELD

Embodiments of the present disclosure generally relate to the field of communication, and in particular, to methods, devices, apparatuses and computer readable storage medium for uplink transmission power control.

### BACKGROUND

With the development of communication technology, many of the services, e.g., enhance mobile broadband (eMBB), massive machine type communications (mMTC), ultra-reliable low latency communications (uRLLC), etc. are quite demanding on high bandwidth, low-latency and ultra-reliability. Simultaneous uplink (UL) transmissions in the same cell will be specified in Release 18 new radio (NR).

On the other side, based on existing specifications, a terminal device is allowed to perform simultaneous UL transmissions in different cells. It's essential for the network to have good and dynamic control on the power level for UL transmissions in the same cell or in different cells, especially simultaneous UL transmissions. Therefore, enhancement on uplink transmission power control is required to be investigated to improve system performance.

### SUMMARY

In general, example embodiments of the present disclosure provide methods, apparatuses and computer readable storage medium for uplink transmission power control.

In a first aspect, there is provided a terminal device. The terminal device may comprise one or more transceivers; and one or more processors coupled to the one or more transceivers, and the one or more transceivers are configured with the one or more processors, to cause the terminal device to obtain, from a network device, a power indication, wherein the power indication indicates whether the terminal device is allowed to use a transmission power greater than a threshold; and determine, based on the power indication, the transmission power for one or more uplink transmissions.

In a second aspect, there is provided a network device. The network device may comprise one or more transceivers; one or more processors coupled to the one or more transceivers, and the one or more transceivers are configured with the one or more processors, to cause the network device to determine whether a terminal device is allowed to use a transmission power greater than a threshold; and provide, to the terminal device, a power indication, wherein the power indication indicates whether the terminal device is allowed to use the transmission power greater than the threshold.

In a third aspect, there is provided a method implemented at a terminal device. The method may comprise obtaining, from a network device, a power indication, wherein the power indication indicates whether the terminal device is allowed to use a transmission power greater than a threshold; and determining, based on the power indication, the transmission power for one or more uplink transmissions.

In a fourth aspect, there is provided a method implemented at a network device. The method may comprise determining whether a terminal device is allowed to use a transmission power greater than a threshold; and providing, to the terminal device, a power indication, wherein the power indication indicates whether the terminal device is allowed to use the transmission power greater than the threshold.

In a fifth aspect, there is provided an apparatus of a terminal device. The apparatus may comprise means for obtaining, from a network device, a power indication, wherein the power indication indicates whether the terminal device is allowed to use a transmission power greater than a threshold; and means for determining, based on the power indication, the transmission power for one or more uplink transmissions.

In a sixth aspect, there is provided an apparatus of a network device. The apparatus may comprise means for determining whether a terminal device is allowed to use a transmission power greater than a threshold; and means for providing, to the terminal device, a power indication, wherein the power indication indicates whether the terminal device is allowed to use the transmission power greater than the threshold.

In a seventh aspect, there is provided a terminal device. The terminal device may comprise at least one processor; and at least one memory including computer program codes, wherein the at least one memory and the computer program codes are configured to, with the at least one processor, cause the terminal device to obtain, from a network device, a power indication, wherein the power indication indicates whether the terminal device is allowed to use a transmission power greater than a threshold; and determine, based on the power indication, the transmission power for one or more uplink transmissions.

In an eighth aspect, there is provided a network device. The network device may comprise at least one processor; and at least one memory including computer program codes, wherein the at least one memory and the computer program codes are configured to, with the at least one processor, cause the network device to determine whether a terminal device is allowed to use a transmission power greater than a threshold; and provide, to the terminal device, a power indication, wherein the power indication indicates whether the terminal device is allowed to use the transmission power greater than the threshold.

In a ninth aspect, there is provided a non-transitory computer readable medium comprising program instructions for causing an apparatus to perform at least the method according to third or fourth aspect.

In a tenth aspect, there is provided a computer program comprising instructions, which, when executed by an apparatus, cause the apparatus at least to: obtain, from a network device, a power indication, wherein the power indication indicates whether the terminal device is allowed to use a transmission power greater than a threshold; and determine, based on the power indication, the transmission power for one or more uplink transmissions.

In an eleventh aspect, there is provided a computer program comprising instructions, which, when executed by an apparatus, cause the apparatus at least to: determine whether a terminal device is allowed to use a transmission power greater than a threshold; and provide, to the terminal device, a power indication, wherein the power indication indicates whether the terminal device is allowed to use the transmission power greater than the threshold.

In a twelfth aspect, there is provided a terminal device. The terminal device comprises obtaining circuitry configured to obtain, from a network device, a power indication, wherein the power indication indicates whether the terminal device is allowed to use a transmission power greater than a threshold; and determining circuitry configured to determine, based on the power indication, the transmission power for one or more uplink transmissions.

In a thirteenth aspect, there is provided a network device. The network device comprises determining circuitry configured to determine whether a terminal device is allowed to use a transmission power greater than a threshold; and providing circuitry configured to provide, to the terminal device, a power indication, wherein the power indication indicates whether the terminal device is allowed to use the transmission power greater than the threshold.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example flowchart of a method implemented at a terminal device according to some other embodiments of the present disclosure;

FIG. 3 illustrates an example signaling process which may be used in some embodiments of the present disclosure;

FIG. 4 illustrates another example signaling process which may be used in some embodiments of the present disclosure;

FIG. 5 illustrates an example flowchart of a method implemented at a network device according to example embodiments of the present disclosure;

FIG. 6 illustrates an example simplified block diagram of an apparatus that is suitable for implementing embodiments of the present disclosure; and

FIG. 7 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IOT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Simultaneous UL transmissions in the same cell will be specified in Release 18 new radio (NR). On the other side, based on existing specifications, a terminal device is allowed to perform simultaneous UL transmissions in different cells, considering e.g. inter-band carrier aggregation (CA) cases.

The output power level of the terminal device is defined partially by a UE power class, which defines a nominal maximum output power for QPSK modulation. The UE power class may be different in different operating bands, but the main UE power class is currently set at 23 dBm for all bands.

For example in TS 38.101, UE maximum output power, P_{cmax,f,c}, the lower reduction term or factor was defined. In CA cases, the terminal device is allowed to use a transmission power exceeding 23 dBm under some cases (such as those condition related to duty cycle). Whether it can exceed 23 dBm is evaluated and dynamically decided by the terminal device. Also a 3 dB reduction would need to be considered for P_{cmax,f,c} determination depending on the rules and conditions captured above.

The inventors have noticed that for UL transmissions in the same cell or in different cells, especially simultaneous UL transmissions, it's essential for the network to have a good and dynamic control on the interference level, and more generally on the power level, especially when the terminal device would be transmitting with a high power (e.g., power around 23 dBm or above). From another perspective, depending on the traffic priority or service type/requirements (related e.g. to data rate, latency, reliability), the terminal device may be able to operate with a transmission power below a certain level that would be allocated by the network device.

The inventors further noticed that in the existing specifications and operations, the network cannot dynamically consider and control the UL transmission power, and this would clearly have a negative impact from at least power saving as well as interference management perspectives.

Therefore, according to embodiments of the present disclosure, there is provided a solution for uplink transmission power control. In this solution, a terminal device obtains a power indication from a network device, wherein the power indication indicates whether the terminal device is allowed to use a transmission power greater than a threshold. Based on the power indication, the terminal device determines the transmission power for one or more uplink transmissions. Therefore, the transmission power for the uplink transmission may be well and dynamically controlled, thereby improving communication efficiency and communication performance.

In some other examples, the terminal device may further provide the network device with assistance information regarding whether the terminal device needs to operate with a transmit power greater than a certain level, which may enable the network device to have a good and dynamic control on for example, interference level.

As used herein, the term “beam” may refer to a communication resource. Different beams may be considered as different resources. A beam may also be represented as a spatial filter. A communication device (including the terminal device and the network device) may communicate with another communication device through one or more beams. One beam may include one or more antenna ports and be configured for a data channel, a control channel, or the like. A beam may be configured with a set of resource, or a set of resource for measurement, and a beam may be represented by for example a reference signal and/or related resource for the reference signal. A beam may also represent by a reference cell identifier or resource identifier.

As used herein, the term “TCI state” may refer to transmission configuration indicator state which may be used by a network station to indicate beams to the terminal device. A TCI state may define a quasi-colocation (QCL) source and QCL type for a target reference signal and hence indicates a transmission configuration which includes QCL-relationships between the DL RSs in one RS set. Particularly, a TCI state may include, for example, a TCI state ID, QCL information, etc. The QCL information may include, for example, QLC type A and QLC type B (optional). The QCL information contains for example, a serving cell index and a bandwidth part (BWP) ID, a downlink reference signal Synchronization Signal (SS) /Physical Broadcast Channel (PBCH) block (SSB) or a channel state information reference signal (CSI-RS), and may also contain information on an uplink reference signal, such as sounding reference signals (SRS). According to the information in the TCI state, the terminal device may acquire beam related information.

As used herein, the term “CA” refers to carrier aggregation, which allows mobile operators or devices to combine two or more carriers. It leads to an increase in the capacity of the network and the data rates by exploiting fragmented spectrum allocations. In carrier aggregation, multiple frequency bands are assigned to one device. There are six specific frequencies as follows: 1.4 MHz, 3 MHz, 5 MHz, 10 MHz, 15 MHz, and 20 MHz. These component carriers can be combined to transmit aggregated bandwidth of up to 100 MHz.

It should be noted that, in the present disclosure, an (UL) beam may also refer to spatial relation information, (separate) UL transmission configuration indicator (TCI) state, joint TCI state or common TCI state, spatial filter, power control information (or power control parameters set), panel or panel identity (ID), quasi-colocation information Type-D (or any other type, such as type A, B or C), etc. More generally, all these terms may be used interchangeably.

It is also noted that a UE panel may be identified by an index of corresponding UE capability value set or by a panel ID. Alternatively, or additionally, a panel may be identified or associated by at least one DL RS (or more generally RS) or simply by an UL beam.

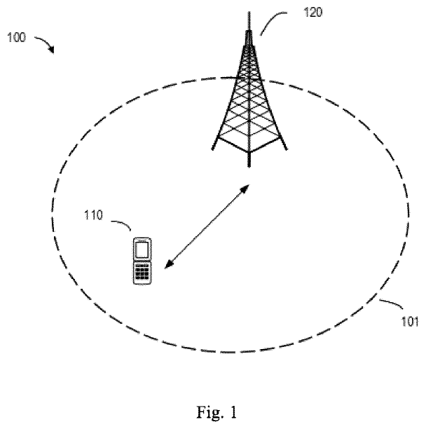

Example embodiments of the present disclosure for beam alignment will be described below with reference to FIGS. 1 to 7.

FIG. 1 illustrates an example network environment 100 in which example embodiments of the present disclosure may be implemented. The environment 100, which may be a part of a communication network, comprises terminal devices and network devices.

As illustrated in FIG. 1, the communication network 100 may comprise a terminal device 110 (hereinafter may also be referred to as user equipment 110 or a UE 110). The communication network 100 may further comprise a network device 120. The network device 120 can manage a cell 101. The terminal device 110 and the network device 120 can communicate with each other in the coverage of the cell 101. A link from the terminal device 110 to the network device 120 is referred to as an uplink (UL), while a link from the network device 120 to the terminal device 110 is referred to as a downlink (DL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connection (DC), and new radio unlicensed (NR-U) technologies.

In some embodiments of the present disclosure, the network device 120 may determine whether a terminal device is allowed to use a transmission power greater than a threshold; and provide, to the terminal device 110, a power indication, wherein the power indication indicates whether the terminal device is allowed to use the transmission power greater than the threshold.

In some embodiments of the present disclosure, the terminal device 110 obtains a power indication from a network device 120, wherein the power indication indicates whether the terminal device is allowed to use a transmission power greater than a threshold. The terminal device 110 determines the transmission power for one or more uplink transmissions based on the power indication. Then, the network device 120 may perform uplink transmission power control.

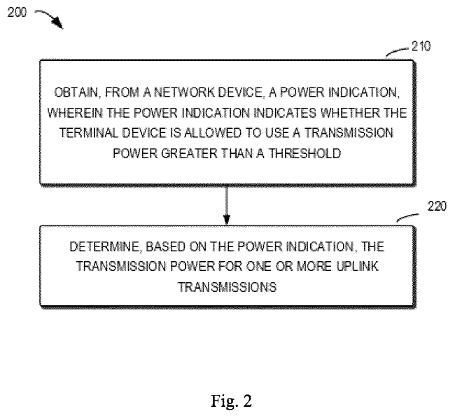

FIG. 2 illustrates an example flowchart of a method 200 implemented at a terminal device 110 according to some embodiments of the present disclosure. For the purpose of discussion, the method 200 will be described from the perspective of the terminal device 110 with reference to FIG. 1. It is to be understood that method 200 may further include additional blocks not shown and/or omit some shown blocks, and the scope of the present disclosure is not limited in this regard.

At block 210, the terminal device 110 obtains a power indication from a network device 120, wherein the power indication indicates whether the terminal device is allowed to use a transmission power greater than a threshold. In other word, the network device 120 indicates whether the terminal device is allowed to use a transmission power greater than a threshold to the terminal device. It is to be understood that “a threshold” is not limited to one threshold, it can include one or more thresholds.

The terminal device 110 may receive, from the network device 120, the power indication on whether or not the terminal device 110 can use a transmission power greater than one threshold of at least one configured threshold. For example, the power indication may be received by medium access control control element (MAC CE), or downlink control indication (DCI). In an example, new or existing field/bits in DCI and/or MAC CE may be used to carry this power indication.

In some embodiments, the terminal device 110 may further receive a power configuration from the network device, for example before receiving the power indication. The power configuration provides information that enable a reception of power indication at the terminal device 110. The power configuration may be carried by, for example, a radio resource control, RRC, message. For example, the terminal device 110 may be configured (e.g., via RRC message) to receive such indication within DCI, physical downlink control channel (PDCCH) (e.g., with specific format), or some existing or new MAC CE.

In some embodiments, the terminal device 110 may obtain offset information for the transmission power. The offset information indicates a power amount by which the transmission power is allowed to exceed the threshold. In an example, when the terminal device 110 is indicated that it can use a transmit power greater than a threshold, the network device 120 may additionally indicate the terminal device 110 an offset. The offset may indicate by how much the terminal device 110 is allowed to exceed the threshold.

In some embodiments, the offset information may be included in the power indication. In some embodiments, the offset information may be configured by a separate message, such as an RRC signaling. For example, new or existing field/bits in DCI and/or MAC CE may be used to carry this indication of offset. The indication of offset may be even carried via RRC signaling. In some embodiments, the offset information may be defined by the communication specifications.

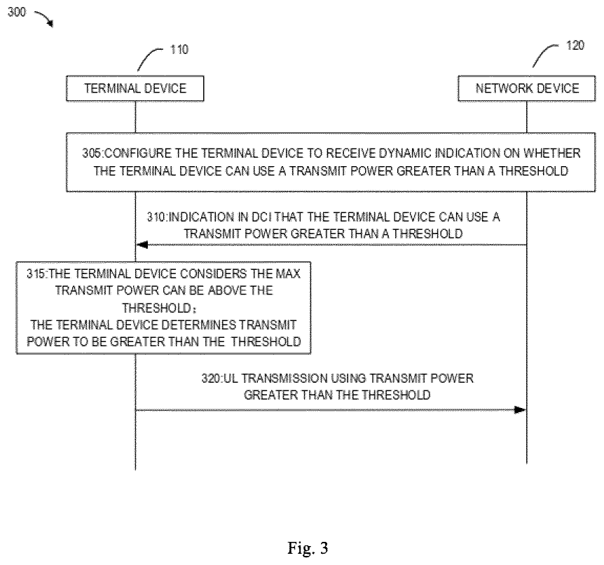

In some embodiments, the terminal device 110 may further receive the threshold from the network device. In an example, the threshold may be either configured by the gNB or defined in communication specifications. For another example, the threshold may be contained in the power indication or in the power configuration. For example, different thresholds might be defined for different terminal device power classes. An example signaling process is illustrated in FIG. 3, which will be described in detail with reference to FIG. 3 later.

In some embodiments, additionally or alternatively, the terminal device 110 may determine whether the terminal device needs to use a transmission power greater than the threshold based on a power usage related condition. The power usage related condition may comprise one or more of: traffic priority, uplink transmission scheme or mode, service type, service requirements, logical channel priority, physical channel priority, coverage situation or channel quality.

Then the terminal device 110 may transmit a power request to the network device 120, the power request indicates that the terminal device 110 needs to use the transmission power greater than the threshold or another threshold. In some embodiments, the power request may also indicate that the terminal device 110 does not need to use the transmission power greater than the threshold. The threshold indicated in the power request may be equal to the threshold indicated in the power indication, and the two threshold may also be different.

In an example, the terminal device 110 may report or request whether it needs or prefers to use a transmit power greater than a configured threshold. This decision on the report or request may be based on traffic priority, uplink transmission scheme or mode (e.g., simultaneous UL transmission vs single panel UL transmission), service type, service requirements (regarding latency, data rate, reliability, etc.) or logical channel priority, physical channel priority. Alternatively, or additionally, this decision may be based on coverage situation (whether the terminal device is limited in coverage) or channel quality, e.g. based on whether some measurement, such a reference signal receiving power (RSRP) is below a configured threshold.

In some embodiments, the power request may be transmitted per waveform type, and the waveform type may be indicated in the power request. In some embodiment, the power request is transmitted as uplink control information (UCI) on physical uplink control channel (PUCCH) or physical uplink shared channel (PUSCH).

In some embodiments, the power request may be sent when the waveform type changed. In some embodiments, the power request may be transmitted per numerology. For example, the waveform type duty cycle may be smaller if transmit power is higher. So, if the transmit power is above the threshold, the duty cycle may be smaller.

In an example, the thresholds and/or offsets may be associated with or corresponding to different duty cycle related information/values and/or operations. Hence, when the terminal device 110 uses, or is indicated to use UL power above a certain threshold, the terminal device 110 may then apply the corresponding duty cycle value and/or operation. Similarly, when the terminal device 110 uses/determines and/or is indicated (e.g., via DCI) a certain power control offset, the terminal device 110 may then apply the corresponding duty cycle value and/or operation.

In another example, corresponding duty cycle information/value may be directly indicated to the terminal device via MAC CE or DCI, using new or existing field(s)/bit(s).

In this way, it may enable good and dynamic control of the interference level, and more generally of the power level, especially when the terminal device is performing transmission with high power. The above solution is especially needed when considering simultaneous UL transmissions in the same cell (e.g., for multi-panel UE) or in different cells. It may also be needed when UL is dynamically switched between different waveforms.

For illustrative purposes, FIG. 3 illustrates an example signaling process which may be used in some embodiments of the present disclosure. For the purpose of discussion, the process flow 300 will be described with reference to FIG. 1. It would be appreciated that although the process flow 300 has been described referring to the network environment 100 of FIG. 1, this process flow 300 may be likewise applied to other similar communication scenarios.

As shown in FIG. 3, the terminal device 110 may be configured 305, by an RRC signaling, to receive dynamic indication on whether the terminal device 110 can use a transmit power greater than a threshold. Next, the network device 120 may transmit 310 an indication in DCI that the terminal device 110 can use a transmit power greater than a threshold. After receiving the indication, the terminal device 110 may consider 315 that the maximum transmit power can be exceeding the threshold, then determine the transmit power to be greater than the threshold. After that, the terminal device 110 may perform UL transmission using transmit power greater than the threshold.

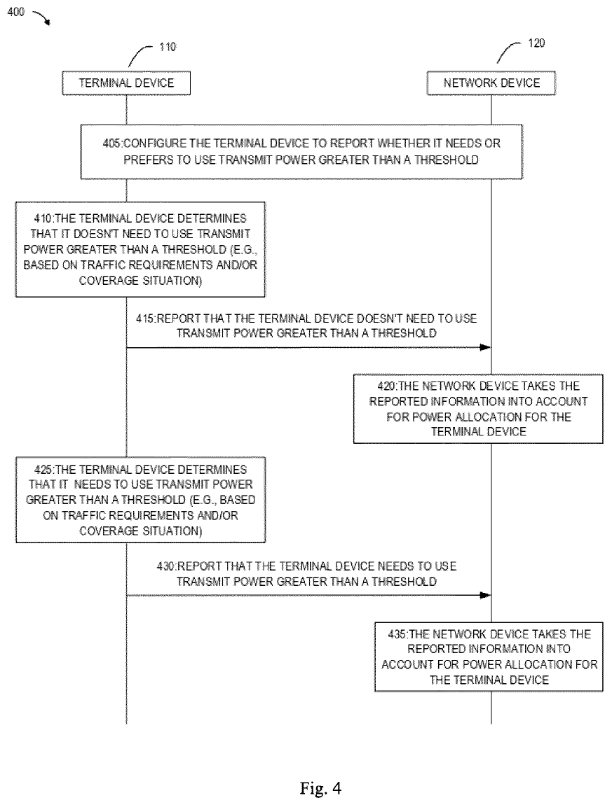

For illustrative purposes, FIG. 4 illustrates an example signaling process which may be used in some embodiments of the present disclosure. For the purpose of discussion, the process flow 400 will be described with reference to FIG. 1. It would be appreciated that although the process flow 400 has been described referring to the network environment 100 of FIG. 1, this process flow 400 may be likewise applied to other similar communication scenarios.

It is further noted that the signaling process as illustrated may be used in combination with that in FIG. 3 or used as a separate solution of a UL transmission power control.

As shown in FIG. 4, the terminal device 110 may be configured 405 to report whether it needs or prefers to use transmit power greater than a threshold. After that, the terminal device 110 may determine 410 that it does not need to use transmit power greater than a threshold (e.g., based on traffic requirements and/or coverage situation). Then the terminal device 110 may report 415 that the terminal device 110 doesn't need to use transmit power greater than the threshold. After receiving the report, the network device 120 may take 420 the reported information into account for power allocation for the terminal device 110.

After a while, the terminal device 110 may further determine 425 that it needs to use transmit power greater than a threshold (e.g., based on traffic requirements and/or coverage situation). Then the terminal device 110 may report 430 that the terminal device 110 needs to use transmit power greater than the threshold. After receiving the report, the network device 120 may take 435 the reported information into account for power allocation for the terminal device 110. Or alternatively, the network device 120 may transmit a response or a power indication to indicate the terminal device that the network device allows the terminal device to use transmit power greater than the threshold.

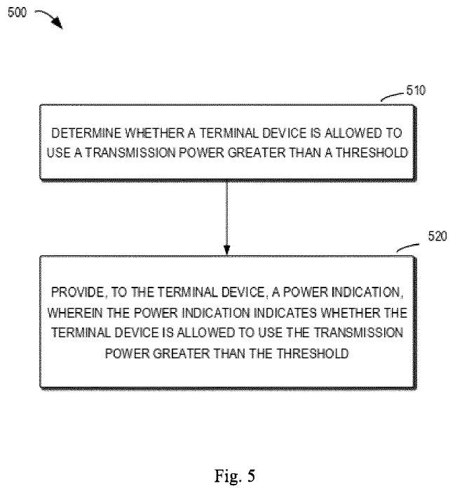

FIG. 5 illustrates an example flowchart of a method implemented at a network device 120 according to example embodiments of the present disclosure. For the purpose of discussion, the method 500 will be described from the perspective of the network device 120 with reference to FIG. 1. It is to be understood that method 500 may further include additional blocks not shown and/or omit some shown blocks, and the scope of the present disclosure is not limited in this regard.

At block 510, the network device 120 determines whether a terminal device 110 is allowed to use a transmission power greater than a threshold.

At block 520, the network device 120 provides a power indication to the terminal device 110, wherein the power indication indicates whether the terminal device 110 is allowed to use the transmission power greater than the threshold.

In some embodiments, based on determining that the power indication indicates the terminal device is allowed to use the transmission power greater than the threshold, the network device 120 may provide offset information for the transmission power to the terminal device. The offset information indicates a power amount by which the transmission power is allowed to exceed the threshold.

In some embodiments, the network device 120 may transmit, to the terminal device 110, one or more of: the threshold; and/or offset information for the transmission power, wherein the offset information indicates a power amount by which the transmission power is allowed to exceed the threshold.

In some embodiments, the network device 120 may transmit, to the terminal device 110, a power configuration providing information that enable a reception of power indication at the terminal device 110.

In some embodiments, the power indication is received by medium access control control element (MAC CE), or downlink control indication (DCI); and/or wherein the power configuration is carried by a radio resource control (RRC) message.

In some embodiments, the network device 120 may receive, from the terminal device, a power request indicating whether the terminal device needs to use the transmission power greater than the threshold or another threshold; and transmit, to the terminal device, a response to the power request, wherein the response indicates whether the power request of the terminal device is denied or accepted.

In some embodiments, the power indication may be provided in the response to the power request.

In some embodiments, the power request may comprise offset information indicating a positive offset or a negative offset by which the transmission power needs to exceed or less than the threshold.

In some embodiments, the network device 120 may provide an indication on whether the positive offset or the negative offset is accepted by the network device In some embodiments, the power request is received per waveform type, and the waveform type is indicated in the power request; and/or wherein the power request is received as uplink control information (UCI), in physical uplink control channel (PUCCH), or physical uplink shared channel (PUSCH).

In some embodiments, the network device 120 may transmit a power request configuration to the terminal device, and the power request configuration indicating the terminal device to transmit the power request.

In some embodiments, the power request configuration may be transmitted by a radio resource control, RRC, message; and/or wherein the power indication may be received by medium access control control element (MAC CE), or downlink control indication (DCI); and/or wherein the power request is transmitted along with or as part of one or more of: a beam report; a power headroom report (PHR); or a maximum permissible exposure (MPE) report.

In some embodiments, a duty cycle value for the one or more uplink transmissions may be applied based on at least one of the offset information or the threshold.

In some embodiments, the one or more uplink transmissions may be associated with one or more of: one or more antenna panels of the terminal device; one or more capability value set indexes; one or more transmission reception points (TRP); one or more control resource sets; one or more sounding reference signal (SRS), resource sets; one or more physical cell identities (PCI); one or more serving cells; or one or more transmission configuration indicator (TCI) states.

In some embodiments, the network device is caused to receive the one or more uplink transmissions with the determined transmission power, the one or more uplink transmissions comprise one or more of: a PUSCH transmission; a PUCCH transmission; a physical random access channel (PRACH) transmission; a SRS transmission; or an uplink channel transmission or uplink signal transmission.

In some embodiments, an apparatus capable of performing any of the method 200 (for example, the terminal device 110) is provided. The apparatus may comprise means for performing the respective steps of the method 200. The means may be implemented in any suitable form. For example, the means may be implemented in a circuitry or software module.

In some embodiments, the apparatus comprises: means for obtaining, from a network device, a power indication, wherein the power indication indicates whether the terminal device is allowed to use a transmission power greater than a threshold; and means for determining, based on the power indication, the transmission power for one or more uplink transmissions.

In some embodiments, the apparatus may comprise: means for obtaining offset information for the transmission power, wherein the offset information indicates a power amount by which the transmission power is allowed to exceed the threshold.

In some embodiments, the apparatus may comprise: means for receiving, from the network device, the threshold.

In some embodiments, the apparatus may comprise: means for receiving, from the network device, a power configuration, wherein the power configuration provides information that enable a reception of power indication at the terminal device.

In some embodiments, the power indication may be received by MAC CE or DCI; and/or the power configuration may be carried by a RRC message.

In some embodiments, the apparatus may comprise: means for determining whether the terminal device needs to use a transmission power greater than the threshold based on a power usage related condition.

In some embodiments, the apparatus may comprise: means for transmitting, to the network device, a power request indicating whether the terminal device needs to use the transmission power greater than the threshold or another threshold.

In some embodiments, the power usage related condition may comprise one or more of: traffic priority, uplink transmission scheme or mode, service type, service requirements, logical channel priority, physical channel priority, coverage situation or channel quality.

In some embodiments, the apparatus may comprise: means for receiving, from the network device, a response to the power request, and the response indicates whether the power request of the terminal device is denied or accepted.

In some embodiments, the power indication may be obtained from the response to the power request. The power request may comprise offset information indicating a positive offset or a negative offset by which the transmission power needs to exceed or less than the threshold.

In some embodiments, the apparatus may comprise: means for obtaining an indication on whether the positive offset or the negative offset is accepted by the network device.

In some embodiments, the power request may be transmitted per waveform type, and the waveform type is indicated in the power request. The power request may be transmitted as UCI on PUCCH or PUSCH.

In some embodiments, the apparatus may comprise: means for receiving, from the network device, a power request configuration indicating the terminal device to transmit the power request.

In some embodiments, the power request configuration may be received by a radio resource control, RRC, message. The power indication may be received by MAC CE or DCI. The power request is transmitted along with or as part of one or more of: a beam report; a PHR; or a MPE report.

In some embodiments, the apparatus may comprise: means for applying a duty cycle value for the one or more uplink transmissions based on at least one of the offset information or the threshold.

In some embodiments, the one or more uplink transmissions are associated with one or more of: one or more antenna panels of the terminal device; one or more capability value set indexes; one or more TRP; one or more control resource sets; one or more SRS resource sets; one or more PCI; one or more serving cells; or one or more TCI states.

In some embodiments, the one or more uplink transmissions comprise one or more of: a PUSCH transmission; a PUCCH transmission; a PRACH transmission; a SRS transmission; or an uplink channel transmission or an uplink signal transmission.

In some embodiments, the apparatus further comprises means for performing other steps in some example embodiments of the method 200. In some example embodiments, the means comprises at least one processor and at least one memory including computer program code, the at least one memory and computer program code configured to, with the at least one processor, cause the performance of the apparatus.

In some embodiments, an apparatus capable of performing any of the method 500 (for example, the network device 120) is provided. The apparatus may comprise means for performing the respective steps of the method 500. The means may be implemented in any suitable form. For example, the means may be implemented in a circuitry or software module.

In some embodiments, the apparatus comprises: means for determining whether a terminal device is allowed to use a transmission power greater than a threshold; and means for providing, to the terminal device, a power indication, wherein the power indication indicates whether the terminal device is allowed to use the transmission power greater than the threshold.

In some embodiments, the apparatus may comprise: means for providing, to the terminal device, offset information for the transmission power based on determining that the power indication indicates the terminal device is allowed to use the transmission power greater than the threshold, the offset information indicates a power amount by which the transmission power is allowed to exceed the threshold.

In some embodiments, the apparatus may comprise: means for transmitting, to the terminal device, one or more of, the threshold; and/or offset information for the transmission power, wherein the offset information indicates a power amount by which the transmission power is allowed to exceed the threshold.

In some embodiments, the apparatus may comprise: means for transmitting, to the terminal device, a power configuration providing information that enable a reception of power indication at the terminal device.

In some embodiments, the power indication may be received by MAC CE or DCI. The power configuration may be carried by a RRC message.

In some embodiments, the apparatus may comprise: means for receiving, from the terminal device, a power request indicating whether the terminal device needs to use the transmission power greater than the threshold or another threshold; and means for transmitting, to the terminal device, a response to the power request, wherein the response indicates whether the power request of the terminal device is denied or accepted.

In some embodiments, the power indication may be provided in the response to the power request.

In some embodiments, the power request may comprise offset information indicating a positive offset or a negative offset by which the transmission power needs to exceed or less than the threshold.

In some embodiments, the apparatus may comprise: means for providing an indication on whether the positive offset or the negative offset is accepted by the network device.

In some embodiments, the power request may be received per waveform type, and the waveform type is indicated in the power request. The power request may be received as uplink control information, UCI, in PUCCH or PUSCH.

In some embodiments, the apparatus may comprise: means for transmitting, to the terminal device, a power request configuration indicating the terminal device to transmit the power request.

In some embodiments, the power request configuration may be transmitted by a RRC message. The power indication may be received by MAC CE, or downlink control indication (DCI). the power request is transmitted along with or as part of one or more of: a beam report; a PHR; or a MPE report.

In some embodiments, a duty cycle value for the one or more uplink transmissions may be applied based on at least one of the offset information or the threshold.

In some embodiments, the one or more uplink transmissions are associated with one or more of: one or more antenna panels of the terminal device; one or more capability value set indexes; one or more TRP; one or more control resource sets; one or more SRS resource sets; one or more PCI; one or more serving cells; or one or more TCI states.

In some embodiments, the apparatus may comprise: means for receiving the one or more uplink transmissions with the determined transmission power, the one or more uplink transmissions comprise one or more of: a PUSCH transmission; a PUCCH transmission; a PRACH transmission; a SRS transmission; or an uplink channel transmission or uplink signal transmission.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

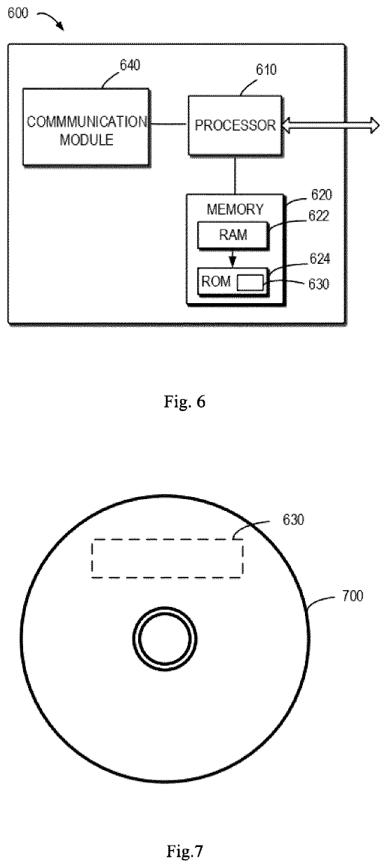

FIG. 6 is a simplified block diagram of a device 600 that is suitable for implementing embodiments of the present disclosure. The device 600 may be provided to implement the communication device, for example the terminal device 110, the network device 120 as shown in FIG. 1. As shown, the device 600 includes one or more processors 610, and one or more transmitters and/or receivers (TX/RX) 640 coupled to the processor 610. The device 600 may further include one or more memories 620 coupled to the processor 610. The device 600 may further include one or more memory 620 storing instructions coupled to the one or more processors 610.

The TX/RX 640 may be for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The communication module 640 may include for example one or more transceivers. The one or more transceivers may be coupled with one or more antennas, to wirelessly transmit and receive communication signals. The one or more transceivers allow the communication device to communicate with other devices that may be wired and/or wireless. The transceiver may support one or more radio technologies. For example, the one or more transceivers may include a cellular subsystem, a WLAN subsystem, and/or a Bluetooth™ subsystem. In some examples, the one or more transceivers may include processors, controllers, radios, sockets, plugs, buffers, and like circuits/devices used for connecting to and communication on networks.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 or 500 as described above with reference to FIG. 2 or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-38. (canceled)

39. A terminal device, comprising:
at least one processor; and
at least one memory including computer program codes, wherein the at least one memory and the computer program codes are configured to, with the at least one processor, cause the terminal device to:
obtain, from a network device, a power indication, wherein the power indication indicates whether the terminal device is allowed to use a transmission power greater than a threshold; and
determine, based on the power indication, the transmission power for one or more uplink transmissions.

40. The terminal device according to claim 39, wherein the terminal device is further caused to:
obtain offset information for the transmission power, wherein the offset information indicates a power amount by which the transmission power is allowed to exceed the threshold.

41. The terminal device according to claim 39, wherein the terminal device is further caused to receive, from the network device, the threshold.

42. The terminal device according to claim 39, wherein the terminal device is further caused to:
receive, from the network device, a power configuration, wherein the power configuration provides information that enable a reception of power indication at the terminal device.

43. The terminal device according to claim 42, wherein the power indication is received by medium access control control element, MAC CE, or downlink control indication, DCI;
and/or
wherein the power configuration is carried by a radio resource control, RRC, message.

44. The terminal device according to claim 39, wherein the terminal device is further caused to:
transmit, to the network device, a power request indicating whether the terminal device needs to use the transmission power greater than the threshold or another threshold.

45. The terminal device according to claim 39, wherein the terminal device is further caused to:
determine whether the terminal device needs to use a transmission power greater than the threshold based on a power usage related condition.

46. The terminal device according to claim 45, wherein the power usage related condition comprises one or more of:
traffic priority, uplink transmission scheme or mode, service type, service requirements, logical channel priority, physical channel priority, coverage situation or channel quality.

47. The terminal device according to claim 44, wherein the terminal device is further caused to:
receive, from the network device, a response to the power request, and the response indicates whether the power request of the terminal device is denied or accepted.

48. The terminal device according to claim 47, wherein the power indication is obtained from the response to the power request.

49. The terminal device according to claim 46, wherein the power request comprises offset information indicating a positive offset or a negative offset by which the transmission power needs to exceed or less than the threshold.

50. The terminal device according to claim 49, wherein the terminal device is further caused to obtain an indication on whether the positive offset or the negative offset is accepted by the network device.

51. The terminal device according to claim 44, wherein the power request is transmitted per waveform type, and the waveform type is indicated in the power request; and/or wherein the power request is transmitted as uplink control information, UCI, in physical uplink control channel, PUCCH, or in physical uplink shared channel, PUSCH.

52. The terminal device according to claim 44, wherein the terminal device is further caused to:
receive, from the network device, a power request configuration indicating the terminal device to transmit the power request.

53. The terminal device according to claim 44, wherein the power request configuration is received by a radio resource control, RRC, message; and/or
wherein the power indication is received by MAC CE, or DCI; and/or
wherein the power request is transmitted along with or as part of one or more of:
a beam report;
a power headroom report, PHR; or
a maximum permissible exposure, MPE, report.

54. The terminal device according to claim 39, wherein the terminal device is further caused to apply a duty cycle value for the one or more uplink transmissions based on at least one of the offset information or the threshold.

55. The terminal device according to claim 39, wherein the one or more uplink transmissions are associated with one or more of:
one or more antenna panels of the terminal device;
one or more capability value set indexes;
one or more transmission reception points, TRP;
one or more control resource sets;
one or more sounding reference signal, SRS, resource sets;
one or more physical cell identities, PCI;
one or more serving cells; or
one or more transmission configuration indicator, TCI, states.

56. The terminal device according to claim 39, wherein the one or more uplink transmissions comprise one or more of:
a PUSCH transmission;
a PUCCH transmission;
a physical random access channel, PRACH, transmission;
a SRS transmission; or
an uplink channel transmission or an uplink signal transmission.

57. A method at a terminal device, comprising:
obtaining, from a network device, a power indication, wherein the power indication indicates whether the terminal device is allowed to use a transmission power greater than a threshold; and
determining, based on the power indication, the transmission power for one or more uplink transmissions.

58. An apparatus, comprising:
means for obtaining, from a network device, a power indication, wherein the power indication indicates whether the terminal device is allowed to use a transmission power greater than a threshold; and
means for determining, based on the power indication, the transmission power for one or more uplink transmissions.
